(19) United States
(12) Patent Application Publication
(10) Pub. No.: US 2022/0239197 A1
(43) Pub. Date: Jul. 28, 2022

(54) ELECTRIC MOTOR COOLING STRUCTURE

(71) Applicant: HONDA MOTOR CO., LTD., Tokyo (JP)

(72) Inventor: Manabu YATSURUGI, Saitama (JP)

(21) Appl. No.: 17/580,733

(22) Filed: Jan. 21, 2022

(30) Foreign Application Priority Data
Jan. 27, 2021 (JP) 2021-011184

(51) Int. Cl. H02K 9/22; H02K 1/32; H02K 9/20

(52) U.S. Cl. CPC H02K 9/225; H02K 9/20; H02K 1/32

(57) ABSTRACT

An electric motor cooling structure includes: a shaft; a rotor arranged on an outer circumference of the shaft; a stator arranged on an outer circumference of the rotor; a magnet received by the rotor; a coolant passage formed on an inner side of the magnet in a radial direction of the shaft; and a heat pipe arranged between the coolant passage and the magnet. The heat pipe includes: a first tubular portion extending in the radial direction of the shaft from a side of the coolant passage to a side of the magnet; and a second tubular portion communicating with an end of the first tubular portion on the side of the magnet and extending in an axial direction of the shaft.

### TECHNICAL FIELD

The present invention relates to an electric motor cooling structure.

### BACKGROUND ART

Conventionally, various methods for cooling an electric motor have been proposed. For example, JP2016-102616A discloses an electric motor cooling structure including a rotor, a shaft fitted to the rotor, and a heat pipe fitted to the shaft. Further, JP2020-78204A discloses an electric motor cooling structure including a rotor, magnets embedded in the rotor, coolant passages penetrating through the rotor on inner diameter sides of the magnets, and heat pipes connecting the coolant passages and the magnets.

In recent years, an Interior Permanent Magnet motor (an IPM motor), which includes a rotor and a magnet embedded in the rotor, has been widely used so as to meet a demand for higher performance of an electric motor. If the magnet becomes hot in such an IPM motor, the magnet is thermally demagnetized, which causes a decrease in the output torque. Accordingly, the temperature of the magnet needs to be strictly controlled.

However, in JP2016-102616A, the heat pipe is arranged inside the shaft. Accordingly, even if a magnet is embedded in the rotor arranged outside the shaft, it is difficult for the heat pipe to cool the magnet effectively.

Further, in JP2020-78204A, the magnets are cooled by rod-shaped heat pipes extending in the radial direction of the shaft. Accordingly, it is impossible for the heat pipes to absorb the heat of the magnets over a wide range in the axial direction of the shaft. Thus, like JP2016-102616A, it is difficult for the heat pipes to cool the magnets effectively.

### SUMMARY OF THE INVENTION

In view of the above background, an object of the present invention is to provide an electric motor cooling structure that can effectively cool a magnet embedded in a rotor.

To achieve such an object, one aspect of the present invention provides an electric motor cooling structure (1) comprising: a shaft (6); a rotor (7) arranged on an outer circumference of the shaft; a stator (8) arranged on an outer circumference of the rotor; a magnet (9) received by the rotor; a coolant passage (P) formed on an inner side of the magnet in a radial direction of the shaft; and a heat pipe (3) arranged between the coolant passage and the magnet, wherein the heat pipe includes: a first tubular portion (21) extending in the radial direction of the shaft from a side of the coolant passage to a side of the magnet; and a second tubular portion (22) communicating with an end (21A) of the first tubular portion on the side of the magnet and extending in an axial direction of the shaft.

According to this aspect, the second tubular portion, which extends in the axial direction of the shaft, is arranged near the magnet, so that the heat pipe can absorb the heat of the magnet over a wide range in the axial direction of the shaft. Accordingly, the heat pipe can cool the magnet effectively.

In the above aspect, preferably, the heat pipe further includes a third tubular portion (23) communicating with an end (21B) of the first tubular portion on the side of the coolant passage.

According to this aspect, the coolant in the coolant passage can cool the heat pipe effectively, so that the heat pipe can cool the magnet more effectively.

In the above aspect, preferably, the coolant passage is arranged inside the shaft and extends in the axial direction of the shaft, the first tubular portion extends over the rotor and the shaft, the second tubular portion is arranged inside the rotor, and the third tubular portion is arranged inside the shaft.

According to this aspect, even if the centrifugal force is applied to the rotor during rotation thereof, the third tubular portion arranged inside the shaft catches on the shaft, so that the rotor can be prevented from shifting outward in the radial direction. Accordingly, the gap between the rotor and the stator can be set to be small, so that the output torque of the electric motor can be improved.

In the above aspect, preferably, the third tubular portion extends in the axial direction of the shaft along the coolant passage.

According to this aspect, the coolant in the coolant passage can cool the third tubular portion more effectively, so that the heat pipe can cool the magnet more effectively.

In the above aspect, preferably, the third tubular portion is bent from the end of the first tubular portion on the side of the coolant passage and extends in a circumferential direction of the shaft.

According to this aspect, the coolant in the coolant passage can cool the third tubular portion effectively while the shape of the heat pipe can be prevented from being complicated.

In the above aspect, preferably, the coolant passage is arranged inside the rotor and extends in the axial direction of the shaft, and the first tubular portion, the second tubular portion, and the third tubular portion are arranged inside the rotor.

According to this aspect, the entirety of the heat pipe is arranged inside the rotor and thus it is not necessary to attach the heat pipe to the shaft, so that the attachment of the heat pipe can be facilitated.

In the above aspect, preferably, the rotor is divided into a first core (43A) and a second core (43B), the first core being arranged on one side of the first tubular portion in the axial direction of the shaft, the second core being arranged on another side of the first tubular portion in the axial direction of the shaft, and the first tubular portion is supported by a support member (46) interposed between the first core and the second core.

According to this aspect, by interposing the first tubular portion of the heat pipe between the first core and the second core of the rotor, it is possible to easily attach the heat pipe to the rotor. Further, by supporting the first tubular portion by the support member, it is possible to improve the positional accuracy of the heat pipe while dividing the rotor in the axial direction of the shaft.

In the above aspect, preferably, the first tubular portion is arranged only in a central portion of the rotor in the axial direction of the shaft.

According to this aspect, it is possible to prevent a magnetic circuit formed by the rotor and the stator from being blocked by the heat pipe, and thus improve the reluctance torque of the electric motor.

Thus, according to the above aspects, it is possible to provide an electric motor cooling structure that can effectively cool a magnet embedded in a rotor.

### BRIEF DESCRIPTION OF THE DRAWING(S)

FIG. 1 is a cross-sectional view showing an electric motor cooling structure according to the first embodiment;

FIG. 2 is a cross-sectional view taken along a central portion of a line II-II in FIG. 1;

FIG. 3 is a cross-sectional view showing an electric motor cooling structure according to the second embodiment;

FIG. 4 is a cross-sectional view taken along a central portion of a line IV-IV in FIG. 3;

FIG. 5 is a cross-sectional view showing an electric motor cooling structure according to the third embodiment;

FIG. 6 is a cross-sectional view taken along a central portion of a line VI-VI in FIG. 5;

FIG. 7 is a cross-sectional view showing an electric motor cooling structure according to the fourth embodiment;

FIG. 8 is a cross-sectional view taken along a central portion of a line VIII-VIII in FIG. 7;

FIG. 9 is a cross-sectional view showing an electric motor cooling structure according to the fifth embodiment; and

FIG. 10 is a cross-sectional view showing an electric motor cooling structure according to a modification of the fifth embodiment.

### DETAILED DESCRIPTION OF THE INVENTION

### The First Embodiment

### <Electric Motor Cooling Structure 1>

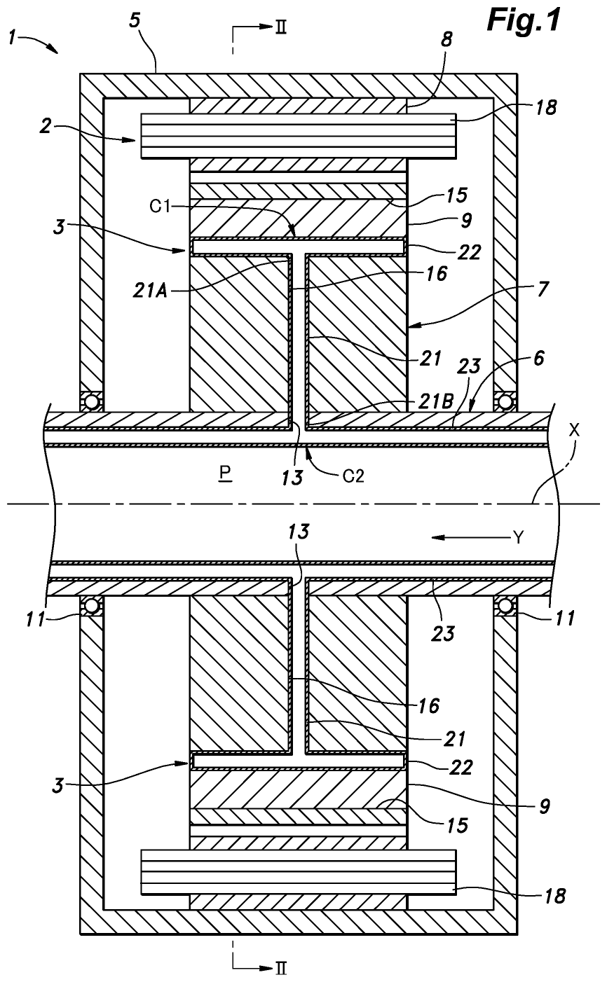

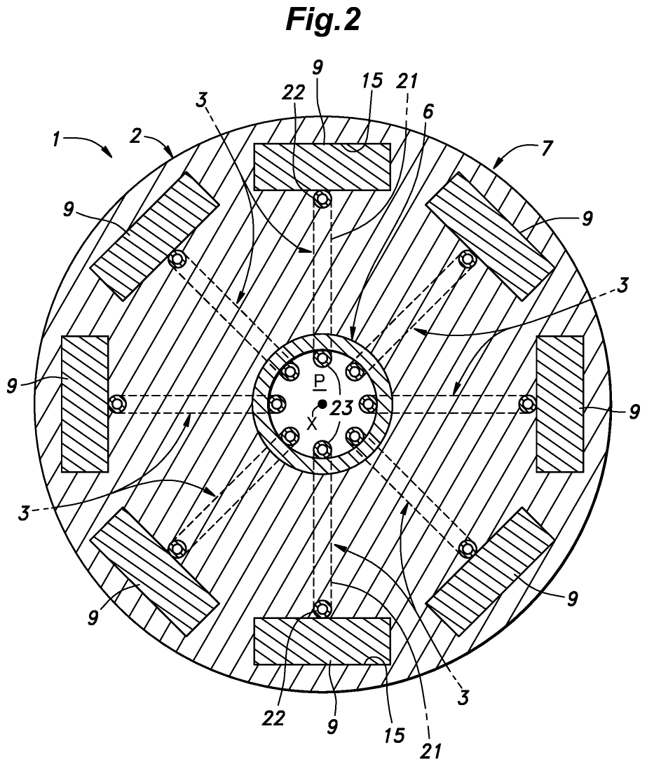

In the following, an electric motor cooling structure 1 according to the first embodiment of the present invention will be described with reference to FIGS. 1 and 2. FIG. 2 shows a cross-section along a central portion of a line II-II in FIG. 1, and does not show a cross-section along an outer circumferential portion of the line II-II in FIG. 1.

The electric motor cooling structure 1 according to the first embodiment includes an electric motor 2 and a plurality of heat pipes 3. Hereinafter, the electric motor 2 and the heat pipes 3 will be described.

### <Electric Motor 2>

For example, the electric motor 2 is used as a driving source for propelling a ship. However, the use of the electric motor 2 is not limited to propulsion of a ship. For example, the electric motor 2 may be used as a driving source for driving a vehicle such as an electric vehicle, a hybrid vehicle, or a fuel cell vehicle, used as a driving source for driving power equipment such as a lawn mower or a snowplow, or used for another purpose.

The electric motor 2 includes a case 5, a shaft 6 penetrating through the case 5, a rotor 7 arranged on an outer circumference of the shaft 6, a stator 8 arranged on an outer circumference of the rotor 7, and a plurality of magnets 9 embedded in the rotor 7. In this way, the electric motor 2 is an Interior Permanent Magnet Motor (IPM motor) including a rotor 7 and a plurality of magnets 9 embedded therein. In another embodiment, the electric motor 2 may be a Surface Permanent Magnet motor (SPM motor) including a rotor 7 and a plurality of magnets 9 attached to an outer circumference thereof.

The case 5 has a bottomed cylindrical shape. The case 5 rotatably supports the shaft 6 via a pair of bearings 11. The case 5 accommodates the rotor 7, the stator 8, and the magnets 9.

The shaft 6 is a hollow metal member. The shaft 6 is configured to rotate around a rotation axis X. The shaft 6 extends in the axial direction along the rotation axis X. Hereinafter, “the axial direction”, “the radial direction”, and “the circumferential direction” in this specification will indicate the axial direction of the shaft 6, the radial direction of the shaft 6, and the circumferential direction of the shaft 6 respectively.

A coolant passage P is arranged inside the shaft 6. The coolant passage P extends in the axial direction along the rotation axis X. The coolant passage P is formed on an inner side of each magnet 9 in the radial direction. A coolant such as an Automatic Transmission Fluid (ATF) is stored in the coolant passage P. An arrow Y in FIG. 1 indicates the direction in which the coolant flows in the coolant passage P. In a central portion of the shaft 6 in the axial direction, a plurality of communication holes 13 are arranged at intervals in the circumferential direction. Each communication hole 13 extends in the radial direction from the coolant passage P to an outer circumferential surface of the shaft 6.

The rotor 7 has a cylindrical shape around the rotation axis X. The rotor 7 is fixed to the outer circumferential surface of the shaft 6, and configured to rotate around the rotation axis X together with the shaft 6. The rotor 7 is formed by stacking a plurality of annular electromagnetic steel sheets in the axial direction. In another embodiment, the rotor 7 may be formed by compressing and molding metal powder. The rotor 7 is not divided into a plurality of parts, but is integrally formed from one end to the other end in the axial direction.

The rotor 7 is provided with a plurality of magnet receiving holes 15 arranged at intervals in the circumferential direction. Each magnet receiving hole 15 extends in the axial direction and penetrates through the rotor 7 in the axial direction. The rotor 7 is provided with a plurality of pipe receiving holes 16 arranged at intervals in the circumferential direction. Each pipe receiving hole 16 extends in the radial direction. An outer end of each pipe receiving hole 16 in the radial direction communicates with the corresponding magnet receiving hole 15. An inner end of each pipe receiving hole 16 in the radial direction communicates with the corresponding communication hole 13 of the shaft 6.

The stator 8 has a cylindrical shape around the rotation axis X. The stator 8 is fixed to an inner circumferential surface of the case 5. An inner circumferential surface of the stator 8 is opposed to an outer circumferential surface of the rotor 7 with a prescribed gap therebetween. The stator 8 is formed by stacking a plurality of annular electromagnetic steel sheets in the axial direction. In another embodiment, the stator 8 may be formed by compressing and molding metal powder.

A plurality of coils 18 is attached to the stator 8 at intervals in the circumferential direction. When each coil 18 is energized, a rotating magnetic field is generated around the stator 8, and thus the shaft 6, the rotor 7, each magnet 9, and each heat pipe 3 rotate integrally relative to the case 5 and the stator 8 by the action of the rotating magnetic field.

The magnets 9 are arranged at intervals in the circumferential direction. For example, each magnet 9 consists of a rare earth element such as neodymium, samarium-cobalt, or praseodymium. In another embodiment, each magnet 9 may consist of ferrite, alnico, or the like. Each magnet 9 is fitted into the corresponding magnet receiving hole 15 arranged in the rotor 7, and thus received by the rotor 7. Each magnet 9 extends in the axial direction and penetrates through the rotor 7 in the axial direction.

### <Heat Pipes 3>

The heat pipes 3 are arranged at intervals in the circumferential direction. For example, each heat pipe 3 is made of metal (aluminum, stainless steel, copper, nickel, or the like) having high heat conductivity. A cross-sectional shape of each heat pipe 3 may be any shape (for example, a circle or a rectangle). An operation liquid composed of water, ammonia, or the like is stored in each heat pipe 3. A wick material, which consists of glass fiber, mesh-like wires, or the like, may be attached to an inner circumferential surface of each heat pipe 3.

Each heat pipe 3 is arranged between the coolant passage P and the corresponding magnet 9 (namely, the magnet 9 corresponding to each heat pipe 3). Each heat pipe 3 is arranged at an inner side of the corresponding magnet 9 in the radial direction, and the position of each heat pipe 3 in the circumferential direction matches that of the corresponding magnet 9 in the circumferential direction. That is, the number of heat pipes 3 is the same as that of magnets 9.

Each heat pipe 3 includes a first tubular portion 21 extending in the radial direction from a side of the coolant passage P to a side of the corresponding magnet 9, a second tubular portion 22 communicating with an end 21A (an outer end in the radial direction) of the first tubular portion 21 on the side of the corresponding magnet 9 and extending in the axial direction, and a third tubular portion 23 communicating with an end 21B (an inner end in the radial direction) of the first tubular portion 21 on the side of the coolant passage P and extending in the axial direction.

The first tubular portion 21 is arranged only in a central portion of the rotor 7 in the axial direction, and is not exposed on both end surfaces of the rotor 7 in the axial direction. The first tubular portion 21 penetrates through each pipe receiving hole 16 of the rotor 7 and each communication hole 13 of the shaft 6. That is, the first tubular portion 21 extends over the rotor 7 and the shaft 6.

The second tubular portion 22 is arranged inside the rotor 7. The second tubular portion 22 is in contact with an inner surface of the corresponding magnet 9 in the radial direction. In another embodiment, the second tubular portion 22 may be opposed to the inner surface of the corresponding magnet 9 in the radial direction with a slight gap therebetween. The second tubular portion 22 penetrates through the rotor 7 in the axial direction. The second tubular portion 22 extends from the end 21A of the first tubular portion 21 on the side of the corresponding magnet 9 to one side and the other side in the axial direction respectively. Accordingly, a communication portion C1 of the first tubular portion 21 and the second tubular portion 22 has a T-shape.

The third tubular portion 23 is arranged inside the shaft 6. The third tubular portion 23 is arranged in an outer portion of the coolant passage P in the radial direction. The length of the third tubular portion 23 in the axial direction is longer than those of the second tubular portion 22 and the rotor 7 in the axial direction. In another embodiment, the length of the third tubular portion 23 in the axial direction may be shorter than those of the second tubular portion 22 and the rotor 7 in the axial direction. The third tubular portion 23 extends from the end 21B of the first tubular portion 21 on the side of the coolant passage P to one side and the other side in the axial direction respectively. Accordingly, a communication portion C2 of the first tubular portion 21 and the third tubular portion 23 has a T-shape.

### <Cooling Operation of Each Magnet 9>

When each magnet 9 generates heat, the second tubular portion 22, which is in contact with the magnet 9, absorbs heat from the magnet 9. That is, the second tubular portion 22 functions as a heat receiving portion of each heat pipe 3. As the second tubular portion 22 absorbs heat from the magnet 9, the operation liquid evaporates in the second tubular portion 22 to become operation steam.

The operation steam generated in the second tubular portion 22 flows into the third tubular portion 23 via the first tubular portion 21. That is, the first tubular portion 21 functions as a heat transfer portion of each heat pipe 3. Incidentally, the central portion of the rotor 7 in the axial direction tends to retain heat as compared with both ends of the rotor 7 in the axial direction. Accordingly, the first tubular portion 21 may absorb heat from the central portion of the rotor 7 in the axial direction. That is, the first tubular portion 21 may function as a heat receiving portion of each heat pipe 3.

The operation steam, which has flowed into the third tubular portion 23, is cooled and condensed by the coolant flowing in the coolant passage P, and thus restored to the operation liquid. Accordingly, the third tubular portion 23 emits heat. That is, the third tubular portion 23 functions as a heat emitting portion of each heat pipe 3. The operation liquid generated in the third tubular portion 23 flows into the second tubular portion 22 via the first tubular portion 21, and evaporates again in the second tubular portion 22. By repeating such heat exchange in each heat pipe 3, the corresponding magnet 9 is cooled.

As described above, in each heat pipe 3 of the present embodiment, the second tubular portion 22, which extends in the axial direction of the shaft 6, is arranged near the corresponding magnet 9. According to such a configuration, each heat pipe 3 can absorb the heat of the corresponding magnet 9 over a wide range in the axial direction of the shaft 6. Accordingly, each heat pipe 3 can cool the corresponding magnet 9 effectively.

Also, each heat pipe 3 further includes the third tubular portion 23 communicating with the end 21B of the first tubular portion 21 on the side of the coolant passage P. According to such a configuration, the coolant in the coolant passage P can cool each heat pipe 3 effectively, so that each heat pipe 3 can cool the corresponding magnet 9 more effectively.

Further, the first tubular portion 21 extends over the rotor 7 and the shaft 6, the second tubular portion 22 is arranged inside the rotor 7, and the third tubular portion 23 is arranged inside the shaft 6. According to such a configuration, even if the centrifugal force is applied to the rotor 7 during rotation thereof, the third tubular portion 23 arranged inside the shaft 6 catches on the shaft 6 (the third tubular portion 23 is hooked to the shaft 6), so that the rotor 7 can be prevented from shifting outward in the radial direction. Accordingly, the gap between the rotor 7 and the stator 8 can be set to be small, so that the output torque of the electric motor 2 can be improved. Further, it is not necessary to form a large rib between each magnet receiving hole 15 and the outer circumferential surface of the rotor 7 to secure the rigidity of the rotor 7 against the above-mentioned centrifugal force. Accordingly, the output torque of the electric motor 2 can be further improved.

Further, the third tubular portion 23 extends in the axial direction of the shaft 6 along the coolant passage P. According to such a configuration, the coolant in the coolant passage P can cool the third tubular portion 23 more effectively, so that each heat pipe 3 can cool the corresponding magnet 9 more effectively.

Further, the first tubular portion 21 is arranged only in the central portion of the rotor 7 in the axial direction of the shaft 6. According to such a configuration, it is possible to prevent a magnetic circuit formed by the rotor 7 and the stator 8 from being blocked by each heat pipe 3, and thus improve the reluctance torque of the electric motor 2.

### The Second Embodiment

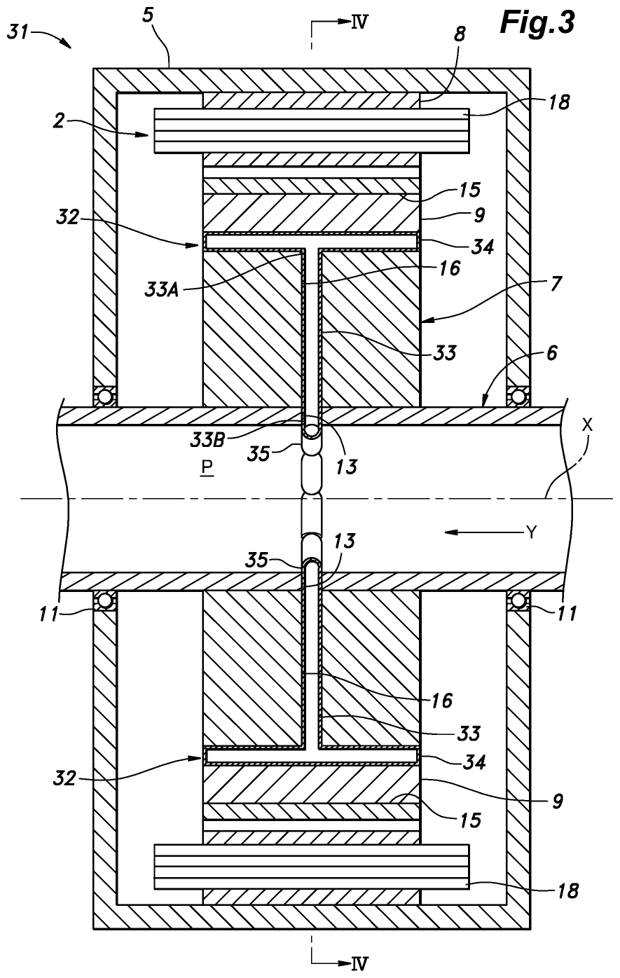

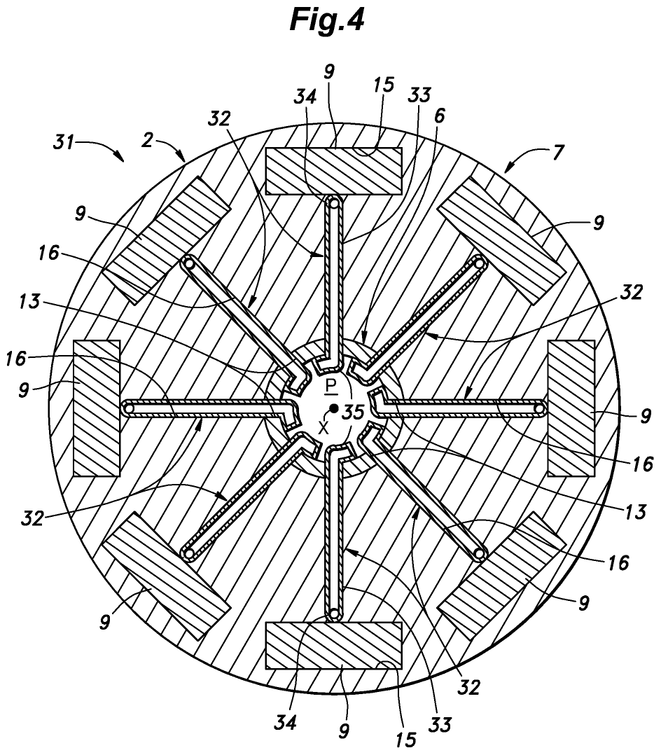

Next, an electric motor cooling structure 31 according to the second embodiment of the present invention will be described with reference to FIGS. 3 and 4. FIG. 4 shows a cross-section along a central portion of a line Iv-Iv in FIG. 3, and does not show a cross-section along an outer circumferential portion of the line IV-IV in FIG. 3. The description which overlaps with that of the electric motor cooling structure 1 according to the first embodiment will be omitted as appropriate.

In the electric motor cooling structure 31 according to the second embodiment, each heat pipe 32 includes a first tubular portion 33 extending in the radial direction from a side of the coolant passage P toward a side of the corresponding magnet 9, a second tubular portion 34 communicating with an end 33A (an outer end in the radial direction) of the first tubular portion 33 on the side of the corresponding magnet 9 and extending in the axial direction, and a third tubular portion 35 communicating with an end 33B (an inner end in the radial direction) of the first tubular portion 33 on the side of the coolant passage P and extending in the circumferential direction. That is, the electric motor cooling structure 31 according to the second embodiment is different from the electric motor cooling structure 1 according to the first embodiment in the configuration of the third tubular portion 35 of each heat pipe 32.

The third tubular portion 35 of each heat pipe 32 is bent from the end 33B of the first tubular portion 33 of each heat pipe 32 on the side of the coolant passage P so as to be perpendicular to the axial direction, and extends along an inner circumferential surface of the shaft 6. The third tubular portions 35 of the heat pipes 32 are arranged at intervals in the circumferential direction such that the positions thereof in the circumferential direction do not overlap with each other.

The operation steam, which has flowed into the third tubular portion 35 by the same action as the first embodiment, is cooled and condensed by the coolant flowing in the coolant passage P, and thus restored to the operation liquid. Accordingly, the third tubular portion 35 emits heat. That is, the third tubular portion 35 functions as a heat emitting portion of each heat pipe 32.

As described above, in each heat pipe 32 according to the second embodiment, like each heat pipe 3 according to the first embodiment, the third tubular portion 35 is arranged inside the shaft 6. According to such a configuration, even if the centrifugal force is applied to the rotor 7 during rotation thereof, the third tubular portion 35 arranged inside the shaft 6 catches on the shaft 6, so that the rotor 7 can be prevented from shifting outward in the radial direction.

Further, in each heat pipe 32 according to the second embodiment, the third tubular portion 35 is bent from the end 33B of the first tubular portion 33 on the side of the coolant passage P and extends in the circumferential direction of the shaft 6. According to such a configuration, the coolant in the coolant passage P can cool the third tubular portion 35 effectively while the shape of each heat pipe 32 can be prevented from being complicated.

### The Third Embodiment

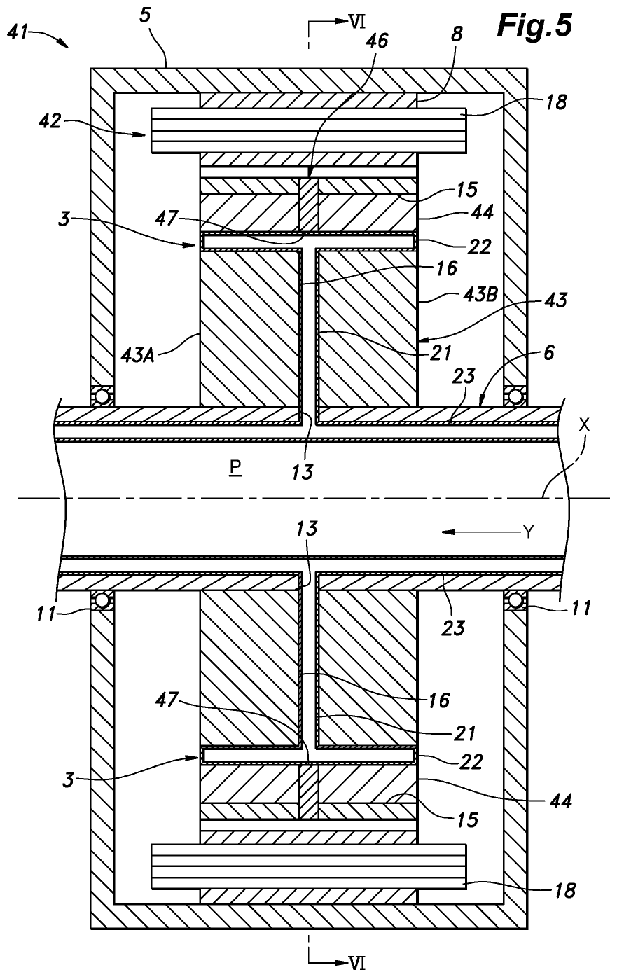

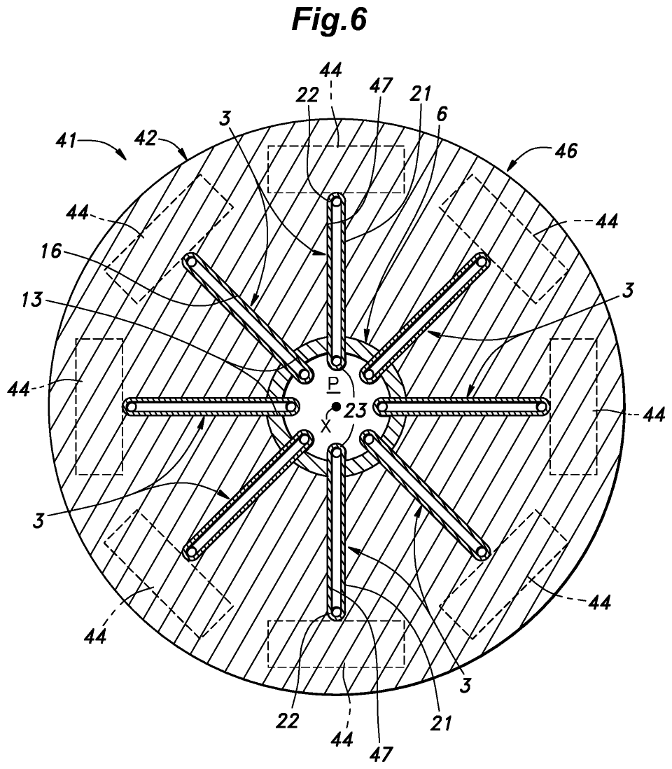

Next, an electric motor cooling structure 41 according to the third embodiment of the present invention will be described with reference to FIGS. 5 and 6. FIG. 6 shows a cross-section along a central portion of a line VI-VI in FIG. 5, and does not show a cross-section along an outer circumferential portion of the line VI-VI in FIG. 5. The description which overlaps with that of the electric motor cooling structure 1 according to the first embodiment will be omitted as appropriate.

In the electric motor cooling structure 41 according to the third embodiment, a rotor 43 of an electric motor 42 is divided into a first core 43A and a second core 43B. The first core 43A is arranged on one side of the first tubular portion 21 of each heat pipe 3 in the axial direction, and the second core 43B is arranged on the other side of the first tubular portion 21 of each heat pipe 3 in the axial direction. That is, the rotor 43 is divided in the axial direction. The first core 43A and the second core 43B are arranged at a prescribed interval in the axial direction.

In the electric motor cooling structure 41 according to the third embodiment, each magnet 44 of the electric motor 42 is divided in the axial direction, like the rotor 43. In another embodiment, in a case where the rotor 43 is divided in the axial direction, each magnet 44 may not be divided in the axial direction.

A support member 46 having a flat plate-like shape is interposed (sandwiched) between the first core 43A and the second core 43B of the rotor 43. When made of the same material as the rotor 43, the support member 46 may be formed by stacking a plurality of annular electromagnetic steel sheets in the axial direction. When made of a different material from the rotor 43, the support member 46 may be made of a metal material or an insulative resin material.

The support member 46 is provided with a plurality of pipe support grooves 47 formed radially at intervals in the circumferential direction. Each pipe support groove 47 extends in the radial direction. The first tubular portion 21 of each heat pipe 3 is fitted into the corresponding pipe support groove 47. Accordingly, the first tubular portion 21 of each heat pipe 3 is supported by the support member 46.

As described above, in the electric motor 42 according to the third embodiment, the rotor 43 is divided into the first core 43A and the second core 43B. Accordingly, by interposing the first tubular portion 21 of each heat pipe 3 between the first core 43A and the second core 43B of the rotor 43, it is possible to easily attach each heat pipe 3 to the rotor 43. Further, the first tubular portion 21 of each heat pipe 3 is supported by the support member 46. Accordingly, it is possible to improve the positional accuracy of each heat pipe 3 while dividing the rotor 43 in the axial direction.

### The Fourth Embodiment

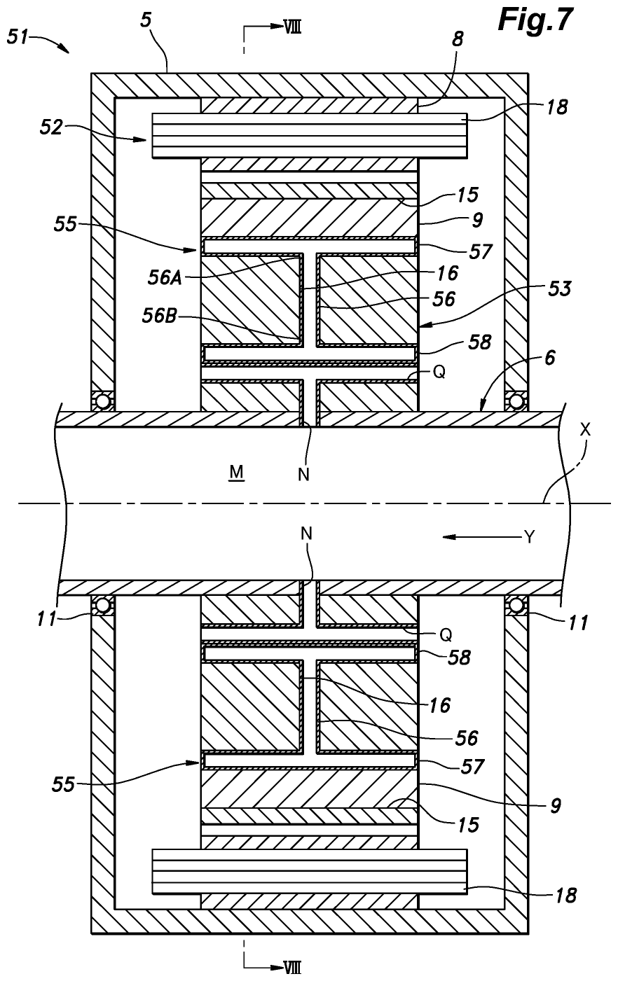

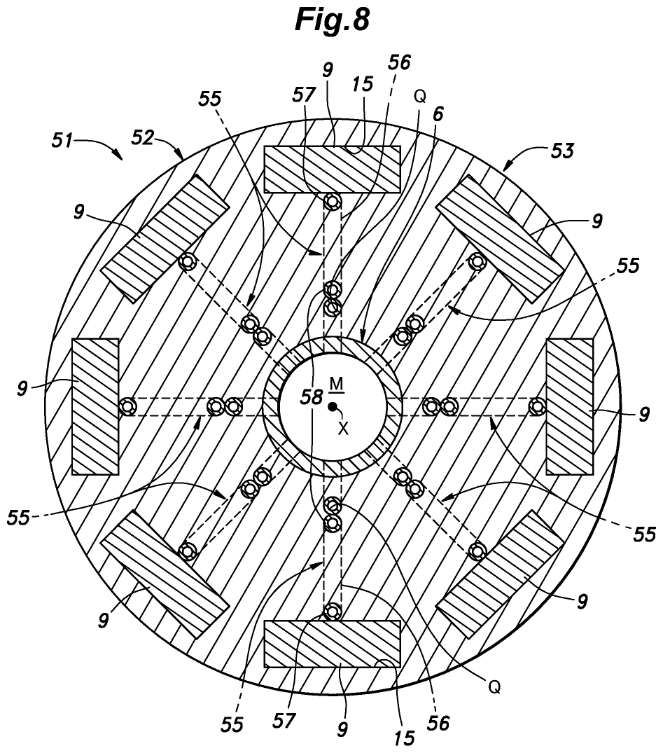

Next, an electric motor cooling structure 51 according to the fourth embodiment of the present invention will be described with reference to FIGS. 7 and 8. FIG. 8 shows a cross-section along a central portion of a line VIII-VIII in FIG. 7, and does not show a cross-section along an outer circumferential portion of the line VIII-VIII in FIG. 7. The description which overlaps with that of the electric motor cooling structure 1 according to the first embodiment will be omitted as appropriate.

In the electric motor cooling structure 51 according to the fourth embodiment, a plurality of coolant passages Q is arranged inside a rotor 53 of an electric motor 52 at intervals in the circumferential direction. Each coolant passage Q extends in the axial direction. Each coolant passage Q is arranged on an inner side of the corresponding magnet 9 in the radial direction, and the position of each coolant passage Q in the circumferential direction matches that of the corresponding magnet 9 in the circumferential direction. The coolant passages Q communicate with a primary passage M, which is arranged inside the shaft 6 and extends in the axial direction, via secondary passages N extending in the radial direction. A coolant such as an ATF is stored in the primary passage M. When the shaft 6 and the rotor 53 rotate, the coolant flowing in the primary passage M flows into each coolant passage Q via the corresponding secondary passage N by the centrifugal force, flows through each coolant passage Q in the axial direction, and then flows out from both ends of each coolant passage Q in the axial direction.

In the electric motor cooling structure 51 according to the fourth embodiment, each heat pipe 55 includes a first tubular portion 56 extending in the radial direction from a side of the corresponding coolant passage Q to a side of the corresponding magnet 9, a second tubular portion 57 communicating with an end 56A (an outer end in the radial direction) of the first tubular portion 56 on the side of the corresponding magnet 9 and extending in the axial direction, and a third tubular portion 58 communicating with an end 56B (an inner end in the radial direction) of the first tubular portion 56 on the side of the corresponding coolant passage Q and extending in the axial direction. All of the first tubular portion 56, the second tubular portion 57, and the third tubular portion 58 are arranged inside the rotor 53.

As described above, in the electric motor cooling structure 51 according to the fourth embodiment, the entirety of each heat pipe 55 is arranged inside the rotor 53 and thus it is not necessary to attach each heat pipe 55 to the shaft 6, so that the attachment of each heat pipe 55 can be facilitated.

### The Fifth Embodiment

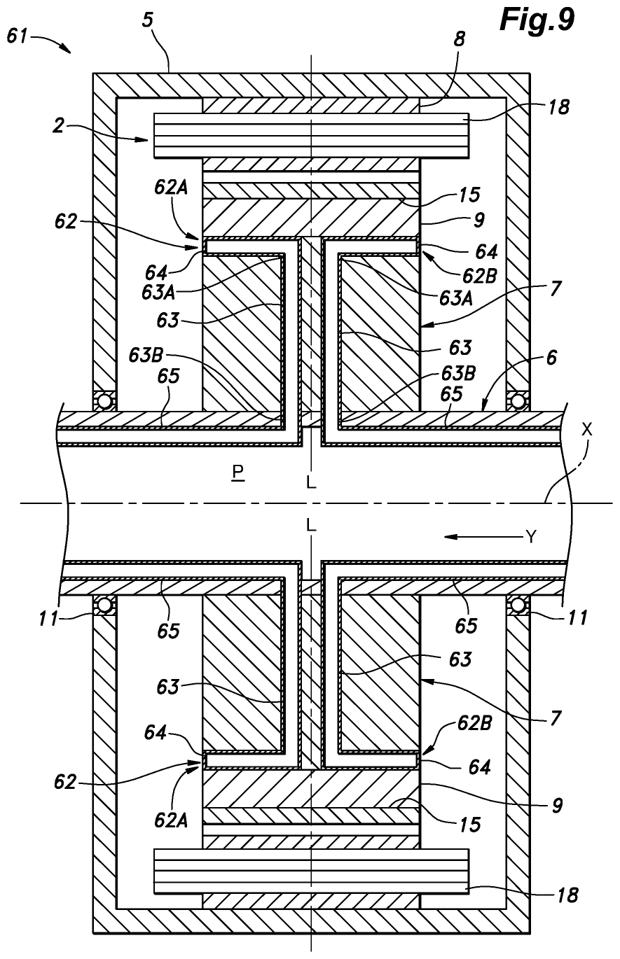

Next, with reference to FIG. 9, an electric motor cooling structure 61 according to the fifth embodiment of the present invention will be described. The description which overlaps with that of the electric motor cooling structure 1 according to the first embodiment will be omitted as appropriate.

In the electric motor cooling structure 61 according to the fifth embodiment, each heat pipe 62 is divided into a first pipe body 62A and a second pipe body 62B. The first pipe body 62A is arranged on one side in the axial direction of a straight line (hereinafter referred to as “rotor centerline L”) passing through the central portion of the rotor 7 in the axial direction. The second pipe body 62B is arranged on the other side in the axial direction of the rotor centerline L. That is, each heat pipe 62 is divided in the axial direction.

The first and second pipe bodies 62A, 62B of each heat pipe 62 are arranged at intervals in the axial direction. In another embodiment, the first and second pipe bodies 62A, 62B of each heat pipe 62 may be in contact with each other. The first and second pipe bodies 62A, 62B of each heat pipe 62 have a U-shape and do not include a branch portion.

Each of the first and second pipe bodies 62A and 62B of each heat pipe 62 includes a first tubular portion 63 extending in the radial direction from a side of the coolant passage P to a side of the corresponding magnet 9, a second tubular portion 64 communicating with an end 63A (an outer end in the radial direction) of the first tubular portion 63 on the side of the corresponding magnet 9 and extending in the axial direction, and a third tubular portion 65 communicating with an end 63B (an inner end in the radial direction) of the first tubular portion 63 on the side of the coolant passage P and extending in the axial direction.

The second tubular portion 64 of the first pipe body 62A is bent from the end 63A of the first tubular portion 63 of the first pipe body 62A on the side of the corresponding magnet 9 to one side in the axial direction. That is, the second tubular portion 64 of the first pipe body 62A extends from the end 63A of the first tubular portion 63 of the first pipe body 62A on the side of the corresponding magnet 9 only to the one side in the axial direction. The third tubular portion 65 of the first pipe body 62A is bent from the end 63B of the first tubular portion 63 of the first pipe body 62A on the side of the coolant passage P to the one side in the axial direction. That is, the third tubular portion 65 of the first pipe body 62A extends from the end 63B of the first tubular portion 63 of the first pipe body 62A on the side of the coolant passage P only to the other side in the axial direction.

The second tubular portion 64 of the second pipe body 62B is bent from the end 63A of the first tubular portion 63 of the second pipe body 62B on the side of the corresponding magnet 9 toward the other side in the axial direction. That is, the second tubular portion 64 of the second pipe body 62B extends from the end 63A of the first tubular portion 63 of the second pipe body 62B on the side of the corresponding magnet 9 only to the other side in the axial direction. The third tubular portion 65 of the second pipe body 62B is bent from the end 63B of the first tubular portion 63 of the second pipe body 62B on the side of the coolant passage P to the other side in the axial direction. That is, the third tubular portion 65 of the second pipe body 62B extends from the end 63B of the first tubular portion 63 of the second pipe body 62B on the side of the coolant passage P only to the other side in the axial direction.

As described above, in the fifth embodiment, each heat pipe 62 is divided in the axial direction. According to such a configuration, it is not necessary to form a T-shaped communication portion (see the communication portion C1 of the first tubular portion 21 and the second tubular portion 22 and the communication portion C2 of the first tubular portion 21 and the third tubular portion 23 in the first embodiment) in the heat pipe 62, so that the heat pipe 62 can be easily manufactured.

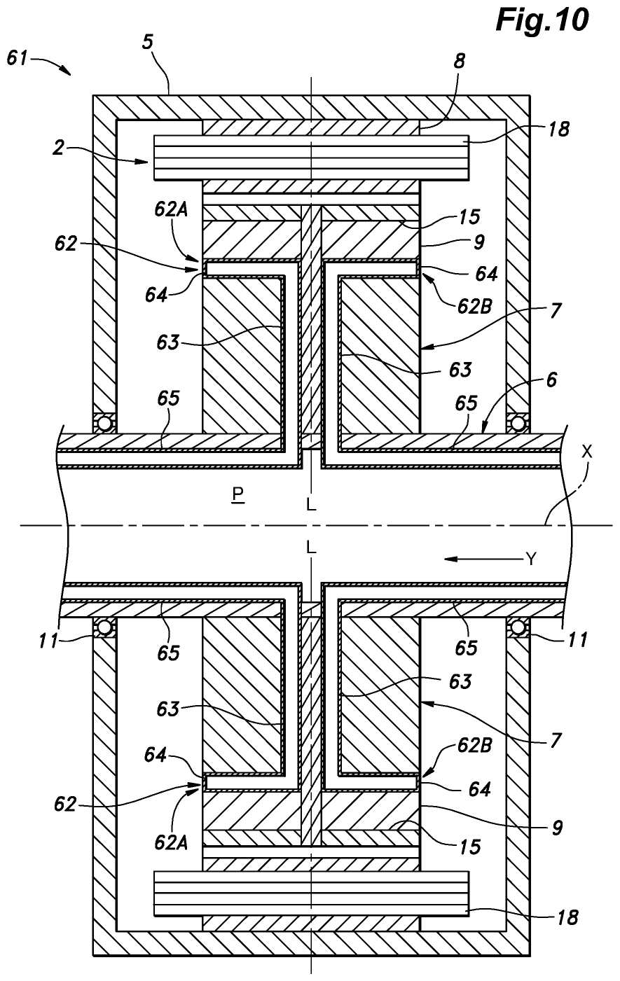

In a modification of the fifth embodiment, as shown in FIG. 10, each heat pipe 62 may be divided in the axial direction, and the rotor 7 may be divided in the axial direction, like the third embodiment. According to such a configuration, not only each heat pipe 62 but also the rotor 7 can be easily manufactured.

Further, in the fifth embodiment, the first and second pipe bodies 62A and 62B are arranged on one side and the other side in the axial direction of the rotor centerline L respectively. On the other hand, in another embodiment, the first and second pipe bodies 62A and 62B may be arranged on the one side and the other side in the axial direction of a straight line that deviates from the rotor centerline L to the one side or the other side in the axial direction. That is, each heat pipe 62 is not necessarily divided at the central portion of the rotor 7 in the axial direction.

Concrete embodiments of the present invention have been described in the foregoing, but the present invention should not be limited by the foregoing embodiments and various modifications and alterations are possible within the scope of the present invention.

1. An electric motor cooling structure, comprising:
a shaft;
a rotor arranged on an outer circumference of the shaft;
a stator arranged on an outer circumference of the rotor;
a magnet received by the rotor;
a coolant passage formed on an inner side of the magnet in a radial direction of the shaft; and
a heat pipe arranged between the coolant passage and the magnet,
wherein the heat pipe includes:
a first tubular portion extending in the radial direction of the shaft from a side of the coolant passage to a side of the magnet; and
a second tubular portion communicating with an end of the first tubular portion on the side of the magnet and extending in an axial direction of the shaft.

2. The electric motor cooling structure according to claim 1, wherein the heat pipe further includes a third tubular portion communicating with an end of the first tubular portion on the side of the coolant passage.

3. The electric motor cooling structure according to claim 2, wherein the coolant passage is arranged inside the shaft and extends in the axial direction of the shaft,
the first tubular portion extends over the rotor and the shaft,
the second tubular portion is arranged inside the rotor, and
the third tubular portion is arranged inside the shaft.

4. The electric motor cooling structure according to claim 3, wherein the third tubular portion extends in the axial direction of the shaft along the coolant passage.

5. The electric motor cooling structure according to claim 3, wherein the third tubular portion is bent from the end of the first tubular portion on the side of the coolant passage and extends in a circumferential direction of the shaft.

6. The electric motor cooling structure according to claim 2, wherein the coolant passage is arranged inside the rotor and extends in the axial direction of the shaft, and
the first tubular portion, the second tubular portion, and the third tubular portion are arranged inside the rotor.

7. The electric motor cooling structure according to claim 1, wherein the rotor is divided into a first core and a second core, the first core being arranged on one side of the first tubular portion in the axial direction of the shaft, the second core being arranged on another side of the first tubular portion in the axial direction of the shaft, and
the first tubular portion is supported by a support member interposed between the first core and the second core.

8. The electric motor cooling structure according to claim 1, wherein the first tubular portion is arranged only in a central portion of the rotor in the axial direction of the shaft.
